(19) United States
(12) Patent Application Publication
(10) Pub. No.: US 2024/0140258 A1
(43) Pub. Date: May 2, 2024

(54) ELECTRIC VEHICLE PLANNING BASED ON CHANGES IN LOAD OR ELEVATION

(71) Applicant: Wireless Advanced Vehicle Electrification, LLC, Salt Lake City, UT (US)

(72) Inventors: Jory Peppelaar, Salt Lake City, UT (US); Michael Masquelier, Salt Lake City, UT (US)

(21) Appl. No.: 17/975,298

(22) Filed: Oct. 27, 2022

(51) Int. Cl. B60L 58/13; G01C 21/34

(52) U.S. Cl. CPC B60L 58/13; G01C 21/3469; B60L 2240/26; B60L 2240/622; B60L 2240/70; B60L 2260/42; B60L 2260/54

(57) ABSTRACT

An energy distribution network may include an energy management server connected to a communication network. One or more electric vehicles may communicate with the server via the network. The system may include charging stations positioned along travel routes of the vehicles. The energy management server may generate and transmit a first energy usage plan to the vehicles. The vehicles may communicate vehicle data information to the server. The vehicle data information may include actual energy usage data and detected changes in load and elevation that may impact energy usage. Based on the received vehicle data, the server may then generate and transmit a second or subsequent energy usage plan to the vehicles. Other examples and embodiments may be described and claimed.

### BACKGROUND

Electric vehicles have experienced advancements in recent years. These advancements include, for example, extended driving range due to higher battery capacities and more sophisticated regenerative braking systems. Other advancements include the ability of charging stations to provide faster charging rates, thereby reducing charging times. These advancements have led to growing acceptance and adoption of electric vehicles.

As electric vehicles become more prevalent on roadways, they are creating a growing demand on public charging infrastructure. Unfortunately, the deployment of new public charging stations lags the sale of new electric vehicles. For individuals who primarily charge their vehicles at home, the lack of public charging stations may be an inconvenience that is only experienced on longer trips. However, for operators of commercial electric vehicles, such as cargo delivery vehicles that require recharging multiple times per day, the scarcity of available charging stations imposes real challenges, including lost productivity while searching for and driving to available charging stations. There is a need more charging infrastructure and better utilization of that charging infrastructure.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a block diagram of an example energy distribution network in which management of energy usage plans for network components that are associated with energy storage systems can be implemented, in accordance with at least one embodiment.

FIG. 2 is a flow diagram of an example methodological implementation for managing the energy usage plans of the energy storage systems in the energy distribution network, in accordance with at least one embodiment.

FIG. 3 is a flow diagram of an example methodological implementation for generating an energy usage plan for a particular energy storage system, in accordance with at least one embodiment.

FIG. 4 is a flow diagram of an example methodological implementation for adjusting the energy usage plan using stored parameter measurement thresholds, in accordance with at least one embodiment

FIG. 5 is a block diagram of an example implementation of energy transfers between network components based on different energy usage plans, in accordance with at least one embodiment.

FIG. 6 is a flow diagram of a method for adjusting the energy usage plan based on changes in elevation or load, in accordance with at least one embodiment.

FIG. 7 is a block diagram of an example energy management server that can facilitate the management of the energy usage plans throughout the energy distribution network, in accordance with at least one embodiment.

FIG. 8 is a block diagram of an example of the elements of an energy consuming component (e.g., a truck or bus) that allow it to monitor its energy usage and communicate data to the energy management server via the energy distribution network in accordance with at least one embodiment.

### DETAILED DESCRIPTION

This disclosure is directed to techniques for managing energy usage plans of network components, specifically energy consuming components such as electric vehicles, that are associated with energy storage systems in an energy distribution network. Energy usage plans may include anticipated energy usages or needs of the energy consuming components in coordination with the energy storage systems and corresponding desired configurations for operating the energy consuming components in coordination with the energy storage systems based upon the anticipated energy usages. Energy usages may include use of the energy storage systems to support energy needs or loads of electric vehicles or charging stations, provide backup power to sustain critical loads during electric grid outages in the charging stations, store energy when grid prices are low then sell the stored energy when grid prices are high, or a combination thereof. Anticipated energy usages may include projected energy usages of the energy consuming components and of the energy storage systems, all or any of which include one or more batteries to store energy. Desired configurations of the energy consuming components may include projected capacities of the batteries in each energy consuming component based upon the anticipated amount of energy to be used. Desired configurations of the energy storage systems may include projected capacities of the batteries based upon the anticipated amount of energy to be used by corresponding electric vehicles or transferred to other electric vehicles or charging station batteries. The desired configurations may also include preconfigured charging plan schedules to obtain the projected capacities and other configurations that relate to providing the anticipated energy usages.

In one embodiment, an initial energy usage plan for the energy storage system of an electric vehicle or a mobile charging station may be dynamically adjusted based upon changing conditions in the energy distribution environment. The conditions, for example, may disrupt the initial energy usage plan such that an adjustment of the initial energy usage plan is required to ultimately complete or perform the anticipated energy usages in this initial energy usage plan. In this embodiment, an adjusted energy usage plan may include a reconfiguration of the energy storage system to address the disrupting conditions. For example, the reconfiguration may include a charging plan rescheduling to maintain a projected capacity or state-of-charge level in the energy storage system. In this example, the charging plan rescheduling may be implemented to obtain the anticipated energy usages in the initial energy usage plan.

As described herein, the energy distribution environment may include the network components such as energy providing components and energy consuming components. Energy providing components may include fixed charging stations, mobile charging stations, electric vehicles when configured as energy providing components, and/or dedicated energy providing electric vehicles that can be charged to supply energy to the energy consuming components. Energy consuming components (or energy consuming devices) may include electric vehicles or mobile charging stations that can be configured to receive energy from the energy providing components.

In one embodiment, an energy management network manager may manage a group of charging stations (i.e., energy providing components) and electric vehicles (i.e., energy consuming components) throughout the energy distribution network. Each of the charging stations may provide energy transfers via an electric grid source, an energy producing source (e.g., solar panel array or diesel-powered electric generator), and/or the energy storage system that includes the use of one or more batteries. Each of the electric vehicles may provide energy transfers through their batteries (i.e., energy storage systems). In this embodiment, the network manager may establish a first energy usage plan that can define a desired initial configuration of the electric vehicles or the charging stations that are associated with corresponding energy storage systems. In one example, the desired initial configuration may correspond to an optimal energy usage of each of the energy storage systems. The optimal energy usage may be determined based upon anticipated energy usages of the batteries, current configurations of the batteries, and/or surrounding conditions over a projected energy usage operating period. The energy usage operating period may include an operating cycle for completion of the projected/anticipated energy usage and can include an hourly cycle, daily cycle, weekly cycle, or other cycles that may be selected by the network manager.

By way of illustration and not limitation, the network manager may establish the first energy usage plan based upon the projected energy needs of a particular electric vehicle, an anticipated amount of energy to be transferred to the particular electric vehicle from other energy storage systems, an anticipated amount of energy to be transferred by the particular electric vehicle to other energy storage systems, or a combination thereof. The network manager may also use current or previously recorded configurations of the particular electric vehicle relative to its projected energy needs to establish the first energy usage plan. Further, the network manager may establish the first energy usage plan based upon characteristics of surrounding conditions such as projected traffic and/or weather conditions, current or known road conditions, and previously recorded or projected cargo loads that may affect the projected energy needs of the particular electric vehicle during the energy usage operating period, which can be one hour, two hours, one day, etc.

Upon configuration of the energy storage system of the particular electric vehicle based upon the first energy usage plan, the network manager may monitor for conditions that can change or disrupt, for example, the ability of the particular electric vehicle to complete a current planned route according to the first energy usage plan. By way of illustration and not limitation, the network manager may receive information regarding weather conditions, road conditions, traffic conditions or changes in current cargo load of a particular electric vehicle that can delay travel time of that particular electric vehicle and as such, disrupts the current capacity and charging plan schedule in the first energy usage plan. In this regard, the network manager may parse the received information to identify the details of the disruption and recalculate an optimal energy usage to generate at least a second or further subsequent energy usage plan.

The recalculation of the optimal energy usage may be based, for example, upon the configuration and the anticipated amount of energy required (i.e., anticipated energy usage) at the time of the occurrence of the disrupting condition. In one embodiment, the second energy usage plan may correspond to an implementation of new configurations in the energy storage system of the particular electric vehicle. For example, the new configurations may implement a different capacity and/or a different charging plan schedule. In this embodiment, the second energy usage plan may implement a dynamic reconfiguration of the energy storage systems based upon dynamically changing conditions. Such dynamically changing conditions may include, for example in an electrically powered delivery truck, changing amounts and weights of cargo as the truck drops off and picks up packages during at least its initial predetermined route. In another example, if the electric vehicle is a passenger bus, the dynamically changing conditions may include the changing number and weights of passengers as the bus stops to drop off or pick up passengers at predetermined locations (i.e., bus stops). These changing conditions are in addition to events such as traffic conditions, weather conditions, and road conditions. Road conditions may include any changes in elevation (e.g., uphill, downhill), changes in road type (e.g., asphalt, concrete, dirt, gravel), and changes in coefficient of friction of the road surface. In some examples, dynamically changing road conditions and weather conditions may be related, such as when the coefficient of friction of a segment of roadway varies with changing weather conditions (e.g., dry, rain, sleet, snow). In some examples, dynamically changing weather conditions and traffic conditions may be related, such as when inclement weather (e.g., snow) results in traffic congestion and slowing travel speeds on a section of roadway.

Such dynamically changing conditions may impact the actual energy usage rates of the electric vehicles. For example, if the truck or bus has a cargo load that is greater than the optimal cargo load anticipated under the first energy usage plan, the period during which the truck or bus has that larger cargo load will use energy at a higher rate than anticipated. On the other hand, if the truck or bus has a cargo load that is lower than the optimal cargo load anticipated under the first energy usage plan, the rate at which the truck or bus is using energy during the period it is carrying the lower load may be lower than anticipated in first energy usage plan.

In the case of changing road conditions, for example, the first energy usage plan may be configured to consider the energy usage of the truck or bus based on all the road segments in a travel route being nominal (e.g., relatively well-paved and maintained, horizontal with little or no inclines or declines, and no weather conditions that would make the roads wet, icy, or otherwise slick). The presence of uphill roads may cause the truck or bus to demand higher levels of energy usage to traverse the uphill road segments. Similarly, roads that are unimproved (i.e., dirt, gravel) may require the truck or bus to experience higher energy usage rates due to road surface roughness or variability that requires a driver to deviant from a constant travel speed (e.g., frequent acceleration and deceleration while traveling on a road segment that has potholes or washboarding). Further, the presence of precipitation (e.g., rain, sleet, snow), or other substances on the road surface that reduce friction and traction may require the truck or bus to experience higher energy use rates than for a dry segment of road. On the other hand, the truck or bus traveling on a downhill slope may instead cause the truck or bus to experience a lower level of energy usage than a flat segment of road. In some embodiments, if the truck or bus travels on a downhill slope where braking is required, a regenerative braking system may be used to partially recharge the battery or batteries of the vehicle. In such embodiments, the electric motor of the truck or bus may operate in reverse and serve as a generator that feeds energy back to the battery, thereby increasing vehicle range.

Details regarding the novel techniques referenced above are presented herein are described in detail, below, with respect to several figures that identify elements and operations used in systems, devices, methods, and computer-readable storage media that implement the techniques.

### Example Energy Distribution Network

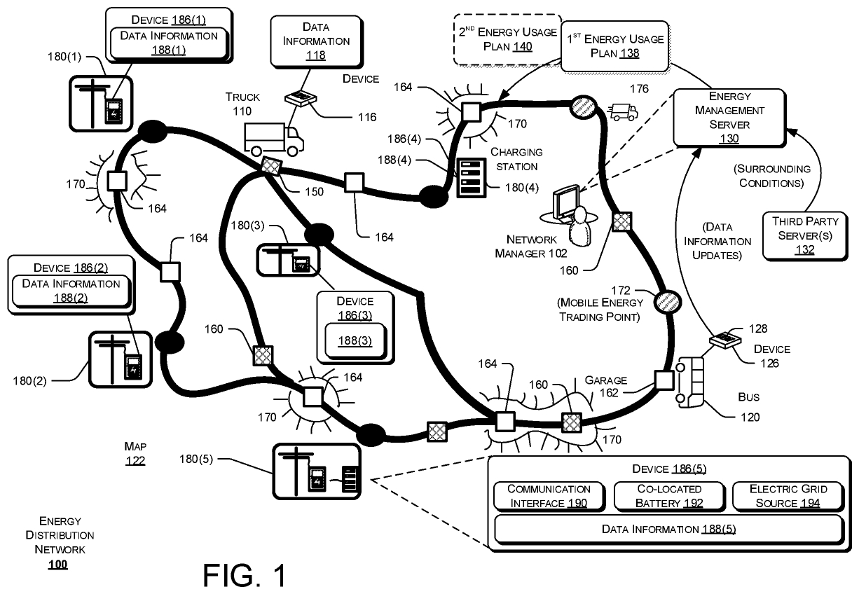

FIG. 1 is a diagram of an example energy distribution network 100 in which the technological solutions described herein may be implemented. FIG. 1 illustrates a concept of managing the energy usage plans (e.g., 138, 140) of network components that are associated with corresponding energy storage systems. In one example, the managing of the energy usage plans may be implemented by a network manager 102 via an energy management server 130. The energy management server 130 may utilize data information from the network components to gather their respective anticipated energy usages and current configurations of their energy storage systems relative to their corresponding anticipated energy usages. In one embodiment, the energy management server 130 may determine an optimal energy usage based upon the gathered anticipated energy usages and current configurations of the network components. The determined optimal energy usage may be used as a reference to generate a first energy usage plan 138. Upon configuration of the network components based upon the first energy usage plan 138, the energy management server 130 may monitor conditions that can trigger an adjustment of the first energy usage plan to create a second energy usage plan 140 or, in the case of multiple sequential adjustments, a subsequent energy usage plan.

The second energy usage plan 140 may be based upon a recalculated optimal energy usage and corresponds to new energy configurations of the network components. These new configurations may be implemented to compensate for the effects of the monitored conditions and complete the anticipated energy usages in the first energy usage plan 138. This technique of dynamically adjusting the energy usage plans may ensure available energy for the anticipated energy needs in the disrupted first energy usage plan and further improve efficiency of energy management operations in the energy distribution network 100.

As shown, the energy distribution network 100 may include a network manager 102 who can manage and control the energy usage plans of the energy storage systems in the energy consuming components and energy providing components, such as, by way of illustration and not limitation, a truck 110 and a bus 120, and stationary charging stations 180(1)-180(5), respectively. The stationary charging stations 180(1)-180(5) are designed to derive the energy they provide to the electric vehicles (e.g., 110, 120) they service from a national, regional, or local electric grid (i.e., an electric grid source), or from batteries co-located and maintained at the stationary charging station, or from a combination of both. The charging stations 180(1)-180(3) may receive energy from the electric grid and provide energy to the energy storage systems of the electric vehicles and mobile charging stations. The charging station 180(5) is an example of a charging station configured to receive energy from the electric grid while also having co-located batteries 192 in which to store energy. The configuration of charging station 180(5) would be useful in situations when the electric grid is temporarily unavailable (i.e., power outages, electricity prices are too high to connect continuously), or where the station experiences a high volume of usage that requires having to charge a large number of vehicles simultaneously. Charging station 180(4) is an example of a charging station equipped only with co-located batteries that would require coordinated recharging from mobile charging stations to remain operational under an energy usage plan. As those skilled in the art will appreciate, the truck 110 and the bus 120 may be treated as mobile energy consuming components that render transportation services between different locations on the map 122. In one example, the truck 110 may be assigned an initial itinerary to provide delivery and/or pickup services from a starting location (e.g., 150) to one or more truck destination points (e.g., 160) while a similar itinerary or schedule for the bus 120 may include driving from a garage 162 to one or more bus stops (geolocations) 164 along a predetermined route. The truck 110 may be associated with an energy management device 116 and data information 118. The bus 120 may be associated with an energy management device 126 and data information 128, as will be described below. During the initial scheduled itinerary or route of either the truck 110 or the bus 120, one or more of the destination points 160 and/or bus stops 164 may be located at or near hills or valleys 170 that form uphill or downhill segments of road (e.g., with varying gradients) that the truck 110 or bus 120 must traverse.

The charging stations 180(1)-180(5) may be treated as energy providing components that can be disposed at different geolocations on the map 122. The charging stations 180(1)-180(5) may each be associated with corresponding control circuit devices 186(1)-186(5), which are associated with data information 188(1)-188(5), respectively, which control the operation of the respective charging station, for example, by providing a communication interface 190 for communicating with the energy distribution management server 130 and other network components, storing the data information, and interfacing with the respective electric grid source 194 and/or co-located battery 192. The control circuit devices 186(1)-186(5) may each include a computer-based or processor-based controller equipped with the requisite processing circuitry and software, wireless/mobile/remote communications circuitry, and power management circuitry to control and manage the operation of the storing and/or transferring energy according to the energy usage plan. As such, the control circuit devices 186(1)-186(5) may be implemented as individual servers, computer terminals, industrial controllers, mobile devices, or other similar devices as would be understood by those of skill in the art.

The charging stations may include one or more similar charging stations or a variety of charging station types. In one example, the charging stations may include a stationary charging station that receives energy from the electric grid (e.g., charging stations 180(1)-180(3)), a charging station equipped with a co-located battery that is not permanently connected to the electric grid (e.g., charging station 180(4)), or a stationary charging station that receives energy from the electric grid source 194 and has a co-located battery 192 (e.g., charging station 180(5)). The charging station 180(5) may include a communication interface 190, a co-located battery 192, and an electric grid source 194.

The charging station 180(4) that includes the co-located battery may be positioned in an off-grid location or in a location where the charging station does not have a permanent connection to the electric grid. In one example, the charging station 180(4) may be a containerized charging station (i.e., a charging station that can be moved to different geolocations by towing, hauling, or other method of transport, as needed to support the energy usage plan). A preferred location for the charging station 180(4) may be determined by the energy management server 130. In one example, the charging station 180(4) may remain in one location for weeks or months. In another example, the charging station 180(4) may be dynamically repositioned during the day to support the energy usage plan. The charging station 180(4) may include a solar panel array that serves to recharge the battery. In an example where the charging station 180(4) is a containerized charging station, the solar panel array may be affixed to one or more exterior surfaces of the container (e.g., top, side surfaces) to simplify repositioning of the container and solar panel array. In some examples, to hasten recharging, the mobile charging station 180(4) may be transported to another charging location where it can be temporarily connected to the electric grid. For example, when moving the charging station 180(4) from a first location to a second location, the mobile charging station 180(4) may be trailered to a charging location where it can be temporarily connected to the electric grid and recharged. Once recharged, the mobile charging station 180(4) may be disconnected from the electric grid and transported to the second location (e.g., where the second location is determined by the energy management server 130).

For purposes of illustration, only two electric vehicles (i.e., truck 110 and bus 120) and five charging stations (i.e., charging stations 180(1)-180(5)) are shown in FIG. 1. However, other network components or nodes such as additional trucks, buses (e.g., commercial, public, school), vans, trains, scooters, electric bicycles, cars, dedicated mobile battery containers, or fixed charging stations may be added to the network. In addition, the embodiments described below for managing energy usage plans of the electric vehicles may be similarly applied to the energy storage systems of the charging stations. In one example, the network manager 102 may utilize one or more servers, such as the energy management server 130 to manage the energy usage plans of the energy storage systems in the truck 110, bus 120, charging station 180(4), and charging station 180(5). The energy management server 130 may also be used to manage distributions of available energy by the electric grid sources in the charging stations 180(1), 180(2), 180(3), and 180(5). In one instance, the energy management server 130 may control and operate the charging stations 180(1)-180(5) while the truck 110 and the bus 120 can be operated by a different server such as a vehicle-to-everything (V2X) server (not shown). In another instance, the energy management server 130 may control and operate the network components in the energy distribution network 100. In one example, the energy management server 130 may generate energy usage plans and further monitor capacities, state-of-charge levels, and/or energy availability of the network components that it controls during the managing of the energy usage plans or energy distribution operation. The energy usage plans may include charging plan schedules or reschedules of a particular electric vehicle or mobile charging station, geolocations for charging or discharging points, identification of the other electric vehicle(s) or charging station(s) that may receive energy from the particular electric vehicle or mobile charging station, and the like.

The truck 110 and the bus 120 may include batteries for energy storage systems and locomotion. In some cases, the truck 110 and the bus 120 can each be propelled by one or more electric motors that use only batteries, or in combination with an internal combustion engine or fuel cell in the case of hybrid electric vehicles. Each electric vehicle may include a vehicle identification number (VIN) that is unique for each such vehicle, embedded sensors including an accelerometer, gyroscope, or other device to measure the inclination or tilt of the electric vehicle while on the road, global navigation satellite system (GNSS) (e.g., Global Positioning System (GPS)) receivers and corresponding navigation applications to identify GPS location, and other applications that may be installed in the vehicle. The vehicle batteries (not shown) of truck 110 and the bus 120 may include one or more rechargeable batteries such as lithium polymer batteries. The vehicle battery or batteries may be associated with parameters such as maximum and minimum operating voltages, maximum self-charge, state-of-charge that can indicate a level of charge of the battery relative to its capacity and discharging rate. These parameters may be configurable to maintain, for example, a target state-of-charge level that corresponds to an amount of energy that, at any given moment, indicates how much energy is needed to complete a task (i.e., anticipated energy usage) in conjunction with a current energy usage plan. The vehicle battery parameters, VIN, and other electric vehicle configurations may be included in the data information (118, 128) of the truck 110 and the bus 120, respectively.

The charging stations 180(1)-180(5) (or collectively referred to as charging stations 180) may be treated as energy providing components that are configured to transfer energy to energy consuming components, such as the truck 110 and the bus 120. As described herein, the charging stations 180 may include batteries, electric grid sources, co-located batteries, or a combination thereof, each configured to at least conduct energy transfer services, including the charging station 180(4) equipped only with batteries, and the charging station 180(5) which includes a co-located battery 192 to provide backup power and to supplement or support the electric grid source 194 in times of emergency, such as when the electric grid source is unavailable, a spike in electric energy prices occurs, or the like. The co-located battery 192 may receive energy from the electric grid source 194 of the same charging station, mobile charging stations 176 dedicated to recharging the batteries of battery-only charging stations or of the electric vehicles, and even energy consuming components, such as the truck 110 or bus 120 that can be configured as energy providing components. The battery of the charging station 180(4) or the co-located battery 192 of the charging station 180(5) may be associated with parameters such a maximum or minimum operating voltage, state-of-charge, capacity, and discharging rates. These parameters may be configurable to maintain, for example, a target capacity or state-of-charge level that corresponds to an amount of energy that, at any given moment, indicates how much energy is needed in conjunction with the current energy usage plan. The battery parameters, co-located battery parameters, charging station identification, information about pairing between the co-located battery and electric grid source in one charging station, and other charging station information may be included in the corresponding data information 188(1)-188(5) of the charging stations 180(1)-180(5).

The energy management server 130 may include general-purpose computers, network servers, or other electronic devices that are capable of receiving input data, processing the input data, and generating output data. The input data may include anticipated energy usages of the energy storage systems during an energy usage operating period, which includes an operating cycle for the completion of the projected/anticipated energy usages, as well as energy usage patterns or data recorded from prior energy distribution plans that the truck or bus used in completing known or predetermined routes. The input data may also include current configurations of the energy storage systems relative to their anticipated energy usages. The input data may further include characteristics of surrounding conditions such as detected or projected traffic conditions, weather conditions, known or anticipated/projected road conditions, spikes in electricity rates from the electric grid, any occurrences of accidents, the presence of events that could impact vehicle routes, traffic or other driving conditions (i.e., public gatherings, holiday occasions, etc.) during the energy usage operating period. The output data may include a calculated or determined optimal energy usage based upon the input data.

In one embodiment, the determined optimal energy usage may be used as a reference to generate a first energy usage plan 138 that can initially define configurations of the network components (i.e., associated with the energy storage systems) throughout the energy distribution network 100. In case of changes in or disruptions to the current energy usage plan that are determined by the energy management server 130, the energy management server 130 may recalculate or redetermine the optimal energy usage based at least on the projected/anticipated energy needs and configurations of the associated network components at the time of change or disruption. The newly determined optimal energy usage may be used as a reference for a second or subsequent energy usage plan 140 depending on how dynamically the energy distribution network is configured to detect and/or redetermine energy usage of every component in the network 100 within a given time period.

By way of illustration and not limitation, as shown in FIG. 1, the energy distribution network 100 further depicts mobile energy trading points 172 that may include preconfigured geolocations for the electric vehicles and/or mobile charging stations 176 to meet and perform energy transfers. In one example, the energy usage plan, such as the first energy usage plan 138 or the second/subsequent energy usage plan 140, may define the geolocations of the mobile energy trading points 172. The preconfigured geolocations of the mobile energy trading points 172 may provide optimal locations to perform the energy transfers in the energy distribution network 100. For example, the truck 110 and the bus 120 may be instructed to have a charging plan schedule that calls for the truck 110 and the bus 120 to travel to the mobile energy trading point 172 as part of their predetermined routes and perform energy transfers based on the first energy usage plan 138. For example, the truck 110 or bus 120 may receive an energy transfer from the mobile charging station 176 and then travel to the mobile energy trading point 172 to either receive an additional energy transfer so it can complete its route or transfer energy to the mobile energy trading point 172 to re-supply the co-located battery there or another electric vehicle. Similarly, the mobile charging station 176 may travel to the mobile energy trading point 172 to either provide or receive an energy transfer. In case of disruption of the first energy usage plan 138, the truck 110 and the bus 120 may be instructed to have a charging plan reschedule that can require traveling to another mobile energy trading point 172 to perform another energy transfer with another electric vehicle, another co-located battery, or another mobile charging station 176 based on the second energy usage plan 140.

In an example embodiment of managing the energy usage plans, the energy management server 130 may obtain anticipated energy usages (or projected energy requirements) of the network components for a particular energy usage operating period, current configurations of the network components relative to the projected energy requirements, characteristics of surrounding conditions during the energy usage operating period, and other (anticipated and/or projected) information during the energy usage operating period that can be used as input data. The energy management server 130 may then use this input data to calculate optimal energy usage and generate a first energy usage plan 138 based on the calculated optimal energy usage. The first energy usage plan 138 may define the desired initial configurations of the network components that are associated with the energy storage systems.

In one embodiment, the first energy usage plan 138, which is based upon the calculated optimal energy usage, may include the desired capacity or state-of-charge level needed to meet or exceed the anticipated energy usages, preconfigured charging plan schedules, preconfigured discharge rates to maintain a required state-of-charge level within the energy usage operating period, maximum limit of energy transfers to be made by batteries, timing of energy transfers to be made based upon availability of batteries or electric grid sources, and/or the amounts of energy to be received by batteries based on their parameters and manufacturing specifications, and the like.

Upon configuration of the network components based on the first energy usage plan 138, the energy management server 130 may monitor conditions that can trigger changes or adjustments to the first energy usage plan 138, resulting in at least one updated, second, or subsequent energy usage plan 140. By way of illustration and not limitation, the monitored conditions may disrupt the calculated optimal energy usage in the first energy usage plan 138 that includes an initial capacity or a state-of-charge level to maintain the supplying of the anticipated energy usages, initial preconfigured charging plan schedules, initial preconfigured discharge rates to maintain a required state-of-charge level within the energy usage operating period, maximum limits of energy transfers to be made by batteries, timing of energy transfers to be made based upon availability of batteries or electric grid sources, and/or the amounts of energy to be received by batteries based on their parameters and manufacturing specifications, and the like. In this example, the disruption may cause the anticipated energy usages of the energy storage systems in the first energy usage plan 138 to either fall short or have excess availability. Accordingly, the energy management server 130 may redetermine the optimal energy usage at the time of disruption, for example, and generate the second or subsequent energy usage plan 140 to overcome the disruption and ultimately complete the anticipated energy usages of all the components in the first energy usage plan 138.

For example, by way of illustration and not limitation, a generated first energy usage plan 138 for the truck 110 to reach all the truck destination points 160 from its starting location 150 may require a charging plan schedule of charging 100 kWh of energy at the charging station 180(4) and a further charging of 100 kWh of energy at the charging station 180(5). In this example, the initial optimal energy usage (i.e., the first energy usage plan 138) for the truck 110 may be calculated based upon its initial state-of-charge and configuration at the start of the energy usage operating period, its initial cargo load (i.e., determined as an average cargo load, a maximum cargo load, or a projected cargo load calculated from historical data and anticipated destinations), anticipated energy usages (e.g., 100 kWh from each charging station) of the truck 110 to reach all the truck destination points 160 along its travel route, and projected conditions such as traffic conditions, road conditions, and weather conditions during the energy usage operating period. In an example where factors such as the actual cargo load and/or the traffic, road, or weather conditions change and delay the expected time of arrival of the truck 110 and thus, disrupt the charging plan schedule and capacity of the truck 110 to reach all the truck destination points 160, the energy management server 130 may recalculate the optimal energy usage associated with the first energy usage plan 138 to generate at least a second or subsequent energy usage plan 140. The second or subsequent energy usage plan can then be provided to the truck 110 so that its travel route can be modified according to the new energy usage plan.

In a further example, the initial optimal energy usage (i.e., first energy usage plan 138) may be calculated based upon anticipated energy usages (e.g., 200+kWh) of the truck 110 to reach all the truck destination points 160, its current configuration at the start of the energy usage operating period (e.g., initial state-of-charge level), its initial cargo load (i.e., determined as an average cargo load, a maximum cargo load, or a projected cargo load calculated from historical data and anticipated destinations), projected environmental conditions such as traffic, road, and weather conditions during the energy usage operating period. In a case where factors such as the actual cargo load and/or the road conditions change or delay the expected time of arrival of the truck 110 or require a higher level of energy usage and thus, disrupt the charging plan schedule and capacity of the truck 110 to reach its next or final destination points 160, the energy management server 130 may recalculate the optimal energy usage associated with the first energy usage plan 138 to generate the second or subsequent energy usage plan 140. In this example, the road or energy usage conditions that could disrupt the charging plan schedule may include hills and valleys, slippery or icy roads, unpaved (i.e., gravel or dirt) roads, and increases or decreases in the actual cargo load of the truck 110 due to dropping off or picking up cargo at one or more destination points 160. In the case of the operation of the bus 120, the actual passenger load of the bus 120 may increase or decrease as passengers enter or exit the bus 120 at each bus stop or other destination 164.

In the example discussed above, a delay may occur and be detected by the energy distribution network 100. The anticipated energy usage of the truck 110 may be 120 kWh based upon its current geolocation, accounting for the presence of hills and valleys in the road, distance to each of the truck destination points 160, the current cargo load of the truck, and projected weather conditions over the rest of the energy usage operating period. In this example, the recalculation of the optimal energy usage (i.e., second energy usage plan 140) may require the truck 110 to travel to the mobile energy trading point 172 and receive an energy transfer before proceeding to the next truck destination point 160. Alternatively, the recalculation of the optimal energy usage (i.e., second energy usage plan 140) may require the truck 110 to travel to the charging station 180(5) and receive an energy transfer before proceeding to the next truck destination point 160. In a further alternative, the recalculation of the optimal energy usage (i.e., second energy usage plan 140) may have the truck 110 bypass traveling to the charging station 180(5) or otherwise receiving an energy transfer before proceeding to the next truck destination point 160 due to actual energy usage being lower than the anticipated energy usage under the first or current energy usage plan. In this example, the energy management server 130 may dynamically recalculate the charging plan schedules and anticipated energy usages of the truck 110 upon the occurrence of the disruption to complete the desired anticipated energy usages (i.e., to reach all the truck destination points 160).

In another example, the anticipated energy usage of the charging station 180(4), which operates on batteries only, may include supplying a total of 1200 kWh of energy to mobile energy consuming components throughout the energy distribution network 100 and for an energy usage operating period of 24 hours. In this example, a calculated first energy usage plan 138 (or optimal energy usage) for the charging station 180(4) may include supplying up to 50 kWh of energy per hour over a predetermined energy usage operating period of 24 hours (i.e., up to 1200 kWh over a one-day period). In one embodiment, this target maximum energy amount may be used as a threshold to detect conditions that can trigger an adjustment of the first energy usage plan 138 for the charging station 180(4). For example, it may be detected that the charging station 180(4) is providing more energy per hour than the threshold level because other charging stations are offline due to, for example, weather conditions, power outages in the electric grid, price spikes associated with the electric grid sources, and other changes or events in the measurement parameters that can cause disruptions in the first energy usage plan 138. In one embodiment, the energy threshold may be used as a reference for detecting these offline occurrences due to weather conditions, power outages, etc. In another embodiment, each of these measurement parameters may have a corresponding measurement threshold that can be used to determine the occurrence of disruptions. For example, an offline measurement threshold may be used to detect the offline conditions as a measured parameter. In another example, a traffic measurement threshold may be used to detect heavy traffic conditions during the predetermined energy usage operating period. In another example, a battery manufacturing specification threshold may be used to detect whether individual or groups of batteries are operating properly. In a particular embodiment, various combinations of these measurement thresholds may be used to detect and identify the disrupting conditions as described herein.

In a further example, GPS receiver data on the location and direction of travel of one or more energy consuming components, in combination with sensors that detect the inclination/declination of each energy consuming component (i.e., for determining whether the truck or bus is traveling uphill or downhill), may be used to determine that one of the energy consuming components has exceeded its energy consumption threshold, which would then be interpreted by the energy distribution management server 130 as a disruption or a potential disruption under the first energy usage plan 138. In another example, sensors in the truck 110 or bus 120 may detect the weight of the load being carried by the truck or bus as the truck or bus moves through its route during the current predetermined energy usage operating period. The sensors may be configured to detect the weight continuously or at predetermined times during the operation of the truck 110 or bus 120. Data from the detected weights may then be transmitted to the energy distribution management server 130 to determine whether the truck or bus has exceeded or will likely exceed its energy consumption threshold, which would then be interpreted by the energy distribution management server 130 as a disruption or a potential disruption under the first energy usage plan 138. As a further example, a combination of the GPS receiver data on the location and direction of travel of truck or bus with sensors that detect the inclination/declination of the truck or bus, along with sensors configured to detect the weight of the truck or bus continuously or at predetermined times during operation, may be used to determine whether the truck or bus has exceeded or will likely exceed its energy consumption threshold, which would then be interpreted by the energy distribution management server 130 as a disruption or a potential disruption under the first energy usage plan 138.

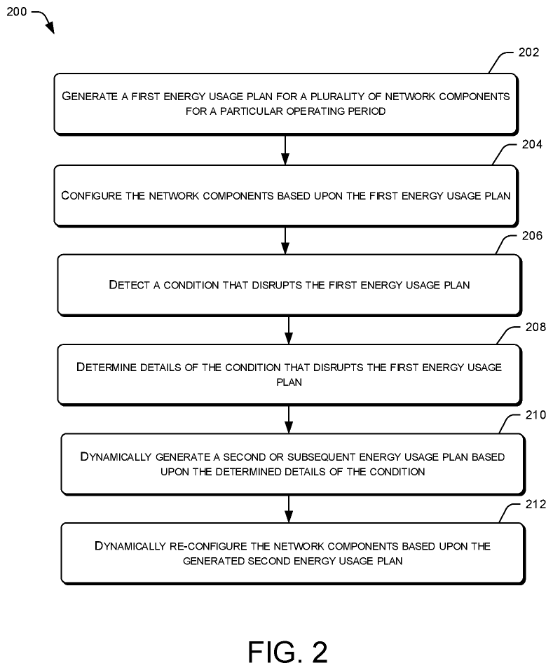

The structure and operation of the energy distribution network 100, with respect to the energy management server 130, may be implemented via various methodologies that will be explained in detail below. The methodologies, as illustrated in FIGS. 2-4, may be implemented via the energy management server 130 in any manner as would be known in the art, including but not limited to software code stored in memory and executed by the energy management server 130; software code stored in one or more memory storage devices or servers remotely located from but executed by the energy management server 130; software code stored in memory and executed by the energy management server 130 that is designed to access software modules stored and executed by remotely located servers to perform specific functions within the methodology; and software code stored in memory and executed by the energy management server 130 that is designed to access third party data sources or servers via a distributed network (e.g., the Internet) to obtain specific data or perform specific functions in support of the methodology.

As will be discussed in further detail, the methodologies illustrated in FIGS. 2-4 are shown as a series of steps or functions that perform the necessary operations for the implementation of the present invention. The methodologies of FIGS. 2-4 implemented as software code may be structured and/or organized in a manner as would be known in art, including but not limited to one or more software modules, wherein each module is designed to perform one or more of the specific steps or functions identified as a step or function in FIGS. 2-4. Such software code may further be structured and organized as, for example, one or more software modules that are stored all together with the energy managing server 130; or a plurality of software modules wherein one or more software modules are stored and/or executed in one or more servers that are remotely located from the energy management server 130; or a plurality of software modules wherein one or more of software modules are implemented as third party databases or applications on third party servers, wherein the energy management server 130 accesses such third party databases or applications as needed to perform the necessary functions and operations of the energy management server 130. Such third-party databases and applications may include but not be limited to GPS-based location and topography databases, weather forecasting databases and applications, traffic reporting databases, vehicle specification databases, battery specification databases, electric grid databases (i.e., availability, outages, current pricing rates), cargo delivery schedule databases, and bus schedule and route databases.

### Example Implementation of Managing Energy Usage Plans

FIG. 2 is a flow diagram 200 that depicts a method of managing the energy usage plans of the energy storage systems in the energy distribution network 100. In the following discussion of FIG. 2, continuing reference is made to the elements and reference numerals shown in and described with respect to the energy management server 130 of FIG. 1. Certain operations may be ascribed to particular elements shown in FIG. 1. However, alternative implementations may execute certain operations in conjunction with or wholly within a different element or component of the system(s). To the extent that certain operations are described in a particular order, it is noted that some operations may be implemented in a different order to produce similar results.

At block 202, the energy management server 130 may generate a first energy usage plan for a plurality of network components that are associated with energy storage systems in an energy distribution network 100. In one example, the energy management server 130 may generate the first energy usage plan 138 for the energy storage systems of the truck 110, bus 120, and charging stations 180(4)-180(5). In this example, the first energy usage plan 138 may define the configurations of the individual network components such that the operation of the individual network components according to their respective configurations are coordinated with one another.

In one example using the truck 110, and by way of illustration and not limitation, the energy management server 130 may obtain the data information of the truck 110 and use the obtained data information to derive its 110 anticipated energy usage for a particular energy usage operating period. The energy management server 130 may also use the data information to obtain the current battery configurations of the truck 110 relative to its anticipated energy needs. The energy management server 130 may further obtain current and projected characteristics of environmental conditions during the energy usage operating period. With this information, the energy management server 130 may calculate an optimal energy usage of the truck 110 based upon the obtained anticipated energy needs, current configurations, and/or characteristics of the surrounding conditions. The energy management server 130 may similarly perform the same operation to obtain the optimal energy usages for the bus 120 and the charging stations (e.g., 180(4), 180(5)). These optimal energy usages may be integrated and used as a reference to generate the first energy usage plan 138.

At block 204, the energy management server 130 may facilitate the configuration of the network components that are associated with energy storage systems based upon the generated first energy usage plan. In one embodiment, each of the network components that are associated with the energy storage systems may be configured based upon the generated first energy usage plan 138. For example, by way of illustration and not limitation, each of the charging stations (e.g., 180(4), 180(5)) may be required to supply a total of 1200 kWh of energy to mobile energy consuming components during an energy usage operating period of 24 hours. In this example, a calculated first energy usage plan 138 for the charging stations (e.g., 180(4), 180(5)) may include each charging station supplying up to 50 kWh of energy per hour over a predetermined energy usage operating period of 24 hours (i.e., up to 1200 kWh over a one-day period). In one embodiment, the energy management server 130 may facilitate the configuration of the charging stations (180(4)-180(5)) based on the calculated first energy usage plan 138. For example, the energy management server 130 may send control signals to the charging stations (180(4)-180(5)) to provide up to 50 kWh of energy per sixty-minute period. In this example, the corresponding devices of the charging stations (180(4)-180(5)) may be configured to comply with the target maximum energy amounts to supply according to the first energy usage plan 138.

At block 206, the energy management server 130 may receive information about a condition that disrupts the first energy usage plan. In one example, the first energy usage plan 138 may be disrupted by an occurrence or absence of an event, availability, or unavailability of the energy storage system, or other conditions that can cause deviations in the desired configurations based on the first energy usage plan 138. In this example, the energy management server 130 may receive the information from the affected one or more network components in the energy distribution network 100. Alternatively, the energy management server 130 may dynamically detect the disruption through continuous monitoring of the network components in the energy distribution network 100.

At block 208, the energy management server 130 may determine the details of the received information about the condition that disrupts the first energy usage plan. In one embodiment, the energy management server 130 may parse the received information to identify the details of the disruption. For example, the details of the received information may include the charging station 180(4) that has discharged more than a predetermined energy threshold. In another example, the details of the received information may include the presence of significant traffic, adverse weather conditions, changes in or deteriorated road conditions (including uphill and downhill roads), changes in the current cargo load of the truck 110 or bus 120, road closures, traffic accidents, etc. that may affect the current configurations of the batteries (i.e., energy storage systems) in at least the energy consuming components (i.e., the truck or bus) based on the first energy usage plan 138. In at least one embodiment, the energy management server 130 may use corresponding parameter measurement thresholds for each of the parameter measurements to detect the disruption of the first energy usage plan. For example, an offline measurement threshold may be used to detect the offline conditions as a measured parameter. In another example, a traffic measurement threshold may be used to detect heavy traffic conditions during the predetermined energy usage operating period. In another example, a battery manufacturing specification threshold may be used to detect proper operations of the batteries, and so on. In a further example, measurement thresholds based on GPS receiver data on the location and direction of travel of the truck or bus, sensor data that detects the inclination/declination of the truck or bus, sensor data that detects the weight of the truck or bus continuously or at predetermined times during operation, or a combination of some or all of these data sources may be used to determine whether the truck or bus has exceeded its energy consumption threshold, or whether the batteries should be operating according to the first energy usage plan.

At block 210, the energy management server 130 may dynamically generate at least a second or subsequent energy usage plan based upon the determined details of the received information. In one example, the energy management server 130 may recalculate the optimal energy usage of affected energy storage systems and/or affected energy consuming systems upon the occurrence of the disruption to generate the second energy usage plan 140. In this example, the second energy usage plan 140 may be applied particularly to the energy consuming components, such as the truck and bus, that are associated with the affected energy storage systems.

In the example above, the first energy usage plan 138 for the charging stations (e.g., 180(4)-180(5)) may include supplying an average energy of 50 kWh each hour an average of 1200 kWhr per 24-hour period. The presence of a disruption that originates from the mobile energy consuming components, such as the truck 110 or bus 120, may affect the current configurations of the charging stations (e.g., 180(4)-180(5)) to discharge or supply energy at this target average energy amount. In one example, due to high demand for energy transfers by the mobile energy consuming components, each of the charging stations (e.g., 180(1)-180(5)) may supply total energy of 700 kWh over a period of ten hours during the energy usage operating period of 24 hours. In this example, each of the charging stations (180(4)-180(5)) may be re-configured to supply only 35 kWh of energy for each remaining hour to satisfy the 1200 kWh threshold requirement. The new 35 kWh configuration may correspond to the second energy usage plan 140 and can be derived by dividing 500 kWh of available energy (i.e., 1200 kWh-700 kWh=500 kWh) by the remaining 14 hours in the day. In an alternative embodiment, each of the charging stations (180(4)-180(5)) may be configured to provide energy to or receive energy from the mobile energy providing components to maintain their desired configurations under the first energy usage plan 138. In this alternative embodiment, the receiving of energy to maintain a desired battery capacity may be included in the first energy usage plan. In a further alternative embodiment, each of the affected mobile energy consuming components may be reconfigured to provide energy to or receive energy from mobile energy providing components to maintain their original configurations under the first energy usage plan. The receiving of energy from mobile energy providing components to maintain the preconfigured battery capacity of the mobile energy consuming components may also be included in the first energy usage plan.

At block 212, the energy management server 130 may dynamically reconfigure the network components in the energy distribution network 100 based upon the generated second energy usage plan 140. In one example, the dynamic reconfiguration may include the re-configuration of the one or more network components that are associated with the affected energy storage systems as described above.

### Example Implementation of Generating an Energy Usage Plan

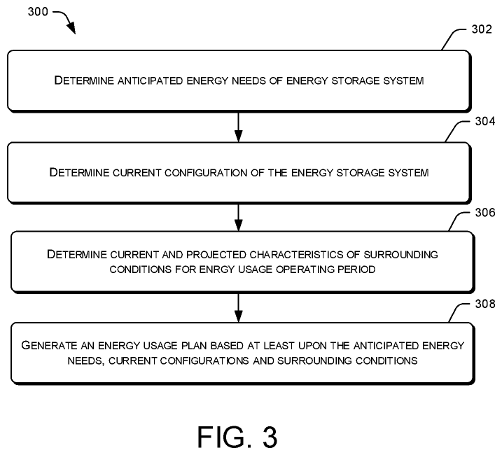

FIG. 3 is a flow diagram 300 that depicts a method of generating an energy usage plan for a particular energy storage system in the energy distribution network 100.

At block 302, the energy management server 130 may determine anticipated energy needs of an energy storage system for a particular energy usage operating period. In one embodiment, the anticipated energy needs of the energy storage system that is associated with the truck 110 or bus 120 may be determined based upon a preconfigured user input such as, an arbitrary value entered in the system by the network manager 102. In another embodiment, the energy management server 130 may directly receive the anticipated energy needs from the truck 110 or bus 120.

For example, by way of illustration and not limitation, the truck 110 may require 100 kWh of energy to travel from its present location 150 to the truck destination point 160. In this example, the amount of anticipated energy needs may be derived from stored or preconfigured user input values, or from the data information of the truck 110. The truck 110, for example, may calculate the anticipated energy needs based on actual distance between its present location 150 and one truck destination point 160, or the distance the truck 110 would have to traverse to travel starting from its initial location 150 to each of the truck destination points 160 in its route and back to the initial location 150. Upon calculation, the truck 110 may send its projected energy needs via sending updated data information 118 to the energy management server 130.

At block 304, the energy management server 130 may determine current configurations of the energy storage system. In the above example, the current configurations of the truck 110 may include battery capacity, state-of-charge level, or operating state of its one or more batteries. In this example, the current configurations of the truck 110 may be correlated with its anticipated energy needs as described in block 302.

At block 306, the energy management server 130 may determine current and projected characteristics of environmental conditions for the particular energy usage operating period. In one example, the characteristics of environmental conditions may include projected traffic and weather conditions, time of day, day of the week, presence of holidays, energy fluctuation rates, road conditions, such as elevation, inclination, declination, type (i.e., asphalt, concrete, gravel, dirt), and/or the like. In this example, the projected characteristics of the environmental conditions may occur during the energy usage operating period.

At block 308, the energy management server 130 may generate an energy usage plan based upon, for example, the anticipated energy needs, current configurations, and the characteristics of the environmental conditions during the energy usage operating period. In one example, the energy management server 130 may use an algorithm to calculate the optimal energy usage for the truck 110 and generate the first energy usage plan 138 based upon the calculated optimal energy usage. The one or more algorithms may include the use of mathematical functions like linear programming, or a prediction model such as a k-means algorithms, maximum likelihood algorithms, random forests algorithms, etc.

For purposes of illustration, FIG. 3 is directed to a method of generating the energy usage plan of the truck 110. However, the same steps (i.e., blocks 302-308) and operations may be applied to generate the energy usage plans for the bus 120, charging station 180(4), and charging station 180(5). Further, the energy usage plan as described herein refers to the energy usage plan of a particular network component or can include the integrated energy usage plans of more than one or all network components that are associated with the energy storage systems. Example Implementation of Adjusting the Current Energy Usage Plan

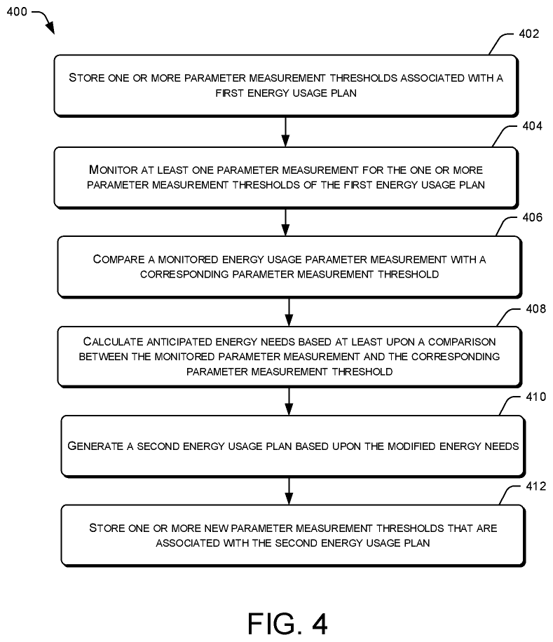

FIG. 4 is a flow diagram 400 that depicts a method of adjusting the energy usage plan using stored parameter measurement thresholds to detect triggering conditions.

At block 402, the energy management server 130 may store one or more parameter measurement thresholds that are associated with a first energy usage plan. In one embodiment, the parameter measurement thresholds that may be associated with the first energy usage plan 138 can be received via a preconfigured user input. The preconfigured user input may be manually entered into the system by the network manager 102. In this embodiment, the parameter measurement thresholds may include reference values that can be used to determine disruptions to the first energy usage plan 138.

For example, by way of illustration and not limitation, a generated first energy usage plan 138 for the truck 110 to reach all the truck destination points 160 from its current location 150 may require a charging plan schedule that provides 1000 kWh of energy. In this example, the initial optimal energy usage (i.e., first energy usage plan 138) or an average energy usage rate may be calculated based upon the anticipated energy usages (e.g., 1000 kWh total at an average energy usage rate of 100 kW over a 10-hour period) of the truck 110 to reach all the truck destination points 160, its current configuration at the start of the energy usage operating period (e.g., minimum state-of-charge level), and projected surrounding conditions such as traffic, road, and weather conditions during the energy usage operating period. This calculated average energy usage rate may be stored and used as a measurement threshold to detect conditions that can trigger an adjustment of the first energy usage plan 138.

At block 404, the energy management server 130 may monitor at least one parameter measurement for the one or more parameter measurement thresholds of the first energy usage plan. Following the example in block 402 above, the energy management server 130 may monitor the discharge rate measurement of the truck 110 or bus 120 for a particular predetermined time period during the energy usage operating period. The discharge rate measurement may correspond to the stored discharge rate measurement threshold. The predetermined time period may include a portion of the predetermined energy usage operating period and can have unit values of minutes, hours, etc.

At block 406, the energy management server 130 may compare a monitored parameter measurement with a corresponding parameter measurement threshold value associated with the first energy usage plan. For example, the truck 110 or bus 120 is monitored to have an average discharge rate measurement of 120 kW during a predetermined time period (e.g., 10 hours) in an energy usage operating period of 24 hours. Since the monitored discharge rate measurement of 120 kW is greater than the discharge rate measurement threshold of 100 kW, then this condition can trigger an adjustment in the configuration of the truck 110 or bus 120. The adjustment in the configuration may include reconfiguring the current route of the truck 110 or bus 120 to include the truck 110 or bus 120 stopping at the charging station 180(4) to receive energy in accordance with a second energy usage plan 140. In addition, the charging station 180(4) would also be reconfigured to provide energy to accommodate the truck 110 or the bus 120 and then use its remaining available stored charge at a recalculated energy discharge rate under the second energy usage plan 140 (e.g., to supply energy to other vehicles).

At block 408, the energy management server 130 may calculate the new or updated anticipated energy needs of the network components based on the comparison of the monitored parameter measurements with the corresponding parameter measurement threshold values that are associated with the first distribution plan in order to determine a second energy usage plan. In at least one example, the comparison analysis by the energy management server 130 to determine a second energy usage plan 140 may include determining an energy usage operating period of 14 hours, which include the number of hours left in the 24 hours, i.e., the energy usage operating period of the first energy usage plan, or a modified energy usage operating period based on the amount of energy distributed to the truck 110 or bus 120, and the available stored energy remaining at the charging stations 180.

At block 410, the energy management server 130 may then generate the second energy usage plan based on the comparison analysis of the monitored parameter measurements with the corresponding parameter measurement threshold values. The generating of the second energy usage plan may include generating one or more new parameter measurement thresholds.

At block 412, the energy management server 130 may store the one or more new parameter measurement thresholds that are associated with the second energy usage plan. Following the example in block 406 above, the new parameter measurement thresholds may include modified discharge rates of the charging stations 180 and for the truck 110 or bus 120 under the second energy usage plan.

In alternative embodiments, the energy management server 130 may use different parameter measurement thresholds other than the discharge rate measurement threshold as described above. For example, a capacity threshold at predetermined time periods within the energy usage operating period may be used to detect the condition that can trigger the adjustment of the initial energy usage plan. In another example, one or more thresholds based on the detection or measurement of traffic conditions, weather conditions, and data from the truck 110 or bus 120 (i.e., GPS location or elevation data, incline/decline position sensor data, weight or load sensor data) may be used to anticipate potential delays as a result of one or a combination of more than one of the parameter thresholds being exceeded or not met within predetermined time periods of the energy usage operating periods.

### Example Energy Transfer Operations Based on Different Energy Usage Plans

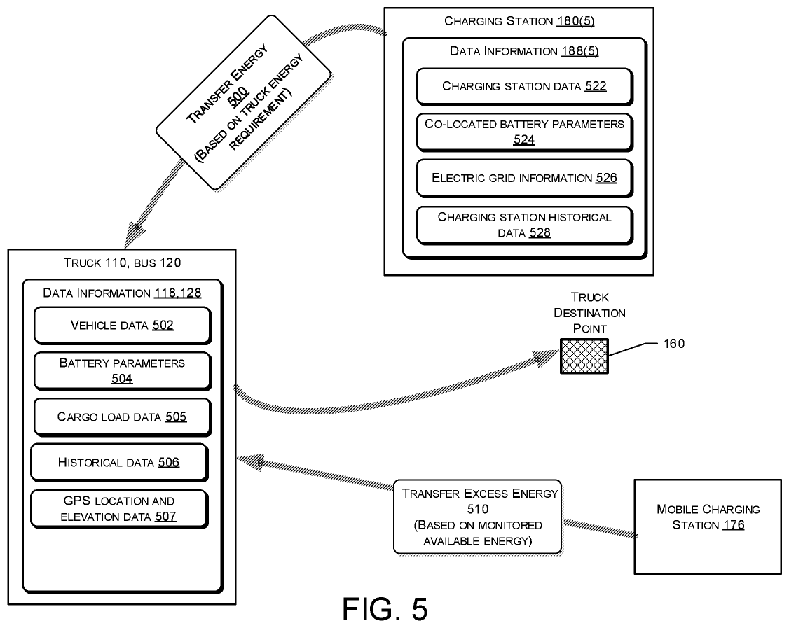

FIG. 5 is a block diagram of an example implementation of energy transfers between the network components based on different energy usage plans. By way of illustration and not limitation, the energy management server 130 may be assumed to control or operate the charging station 180(5), the truck 110 or bus 120 (which may be autonomous vehicles), and the mobile charging station 176 as network components in the energy distribution network 100.

In one embodiment, the charging station 180(5), as an example, and the truck 110 or bus 120 may be configured to have different energy usage operating periods. The energy usage operating period may include the operating cycle for completing a projected/anticipated energy usage of the energy storage systems in the charging station 180(5), and the truck 110 or bus 120. For example, the charging station 180(5) may be configured to have an energy usage operating period of 24 hours to supply 1200 kWh of energy to mobile energy consuming components while the truck 110 or bus 120 may each be configured to have an energy usage operating period of 2 hours and consume 100 kWh of energy when traveling from a geolocation of the charging station 180(5) to the truck destination point 160 or bus stop 164, respectively. In this example, the first energy usage plan (or initial configuration) for the charging station 180(5) may be different from the first energy usage plan (or initial configuration) of the truck 110 or bus 120. By way of illustration and not limitation, the first energy usage plan for the charging station 180(5) may be to discharge energy at an average rate of 50 kW (i.e., 1200 kWh divided by 24 hours) while the first energy usage plan for the truck 110 or bus 120 is to use energy at an average rate of 50 kW (i.e., 100 kWh divided by 2 hours). This is a simplified example that assumes the truck 110 and bus 120 can each operate at a near-empty state-of-charge level to reach the destination point 160 or bus stop 164, respectively.

As shown in FIG. 5, the truck 110 or bus 120 may receive the 100 kWh of energy from the charging station 180(5) via an energy transfer 500. The truck 110 or bus 120 may then be configured to consume energy at a rate of 50 kW for two hours, according to the first energy usage plan. In one embodiment, the energy management server 130 may monitor the truck 110 or bus 120 as it travels towards the truck destination point 160 or bus stop 164, respectively. The energy management server 130 may use, for example, a parameter measurement threshold of 50 kW (i.e., 100 kWh divided by 2 hours) to monitor and detect conditions that may disrupt the initial configuration of the truck 110 or bus 120. If the monitored rate of consumption of the truck 110 or bus 120 is 50 kW, and the truck 110 and bus 120 have travelled partway towards the first destination point 160 or bus stop 164, respectively, then no disruption will be detected.

For purposes of brevity, the example based on the truck 110 referencing FIG. 1 will be used. At the first destination point 160, the truck 110 unloads cargo weighing 1500 pounds and picks up cargo weighing 2500 pounds that is destined for dropping off at the next destination point 160. In addition, the truck encounters a change in elevation associated with a hill or valley 174 was not considered in calculating the first energy usage plan. As a result, the energy management server 130 monitoring the truck 110 as it travels towards the second destination point 160 detects that the monitored rate of energy consumption of the truck 110 within a predetermined time period of 1 hour is 70 kW and the truck 110 has travelled partway towards the second destination point 160. This condition may now indicate that the truck 110 is averaging an energy consumption rate of 70 kW, which is higher than the initial configuration or parameter measurement threshold of 50 kW under the first energy usage plan. In this regard, and upon receiving of this information, the energy management server 130 may recalculate the optimal energy usage for the truck 110.

In another example, the truck 110 may be reconfigured to have a predetermined route modified to include stopping at a mobile energy trading point 172 to rendezvous with the mobile charging station 176 dispatched by the energy management sever 130. The mobile charging station 176 may be configured to provide an energy transfer 510 to the truck 110. In addition to or alternatively, the truck 110 may be reconfigured to have its predetermined route modified to include stopping at the charging station 180(5) that would then also be reconfigured to transfer energy to accommodate the truck 110.

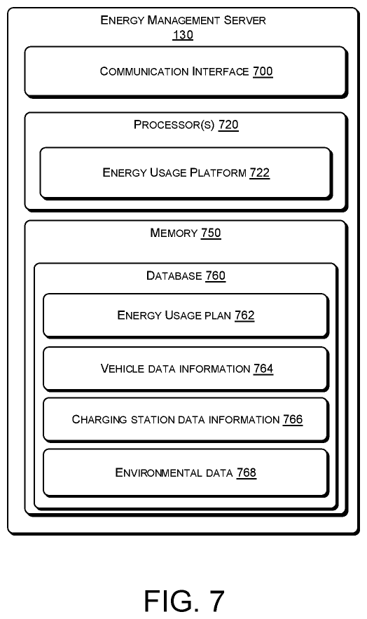

In alternative embodiments, the energy management server 130 may use parameter measurement thresholds other than the energy consumption rate as described above. The energy management server 130 may dynamically change the charging plan schedules of the truck 110 as it travels towards one or more destination points 160 as further described in detail at FIG. 7 below.

Referencing FIG. 5, the data information (118, 128) of the truck 110 or bus 120 may include (electric) vehicle data 502, vehicle battery parameter 504, cargo load data 505, GPS location and elevation data 507, and vehicle historical data 506. The vehicle data 502 may include sensor data on the inclination/declination of the truck 110 that may be correlated with the GPS location data. The data information 188(5) of the charging station 180(5) may include a charging station data 522, co-located battery parameter 524, electric grid information 526, and charging station historical data 528.

Vehicle data 502 may store the VIN that is unique to the vehicle (e.g., 110, 120). Vehicle data 502 may also store the geolocation, a media access control (MAC) address of the energy management device (e.g., 116, 126) that is associated with the vehicle (e.g., 110, 120), respectively, and/or other information about the vehicle. The associated energy management device of the vehicle may include an embedded electronic computer unit (ECU) or other system processors. In an example embodiment, the vehicle may periodically transmit the vehicle data 502 to the energy management server 130.

Battery parameters 504 may include information about the battery of the vehicle (e.g., 110, 120). In one embodiment, the battery parameters 504 may include parameters such as capacity or state-of-charge level, depth of charge, charging and discharging rates of the battery, or the battery lifetime. The state-of-charge may include a fraction of total energy or battery capacity that has been used over the total available energy in the battery. Depth of discharge may include the fraction of charge that can be withdrawn from the battery without causing serious and often irreparable damage to the battery. The charging rate may include the amount of charge that is added to the battery per unit time. Discharging rate may include the amount of charge that is taken from the battery per unit time.

Historical data 506 may include historical records that can be collected from the previous energy transfer sessions performed by the vehicle (e.g., 110, 120). For example, the previous energy transfer sessions may include charging or discharging of energy at the charging station 180(5). The historical data 506 may include records of the previous energy transfers performed by the vehicle (e.g., 110, 120) correlated with geolocation of the charging stations used, the predetermined routes driven, the destination points (e.g., 160, 164) and the road conditions encountered on the predetermined routes. Over time, the historical records may be used as training data to create the prediction model that can be used to predictively determine the optimal distribution of energy or optimal energy usages in the energy distribution network 100.

Charging station data 522 may include information about the charging station 180(5). The information may include, for example, the geolocation and identification of the charging station, media access control (MAC) address of the control circuit device 186(5) that is associated with the charging station 180(5), and prices and availability of the charging station to trade energy whether through the co-located battery 192 or electrical grid source 194. The device associated with the charging station may include processors or system processors. In one embodiment, the charging station 180(5) may periodically transmit the charging station data 522 to the energy management server 130.

Co-located battery parameters 524 may include information about one or more batteries that can be installed in the charging station. In one embodiment, the co-located battery parameters 524 may include parameters such as state-of-charge, depth of discharge, charging and discharging rates of the battery, or the battery lifetime.

Electric grid information 526 may include current prices or cost for charging energy via the electrical grid power source, availability of the electrical grid power source, charging and discharging rate, maximum capacity, and other information that relate to the use of the electrical power source in the charging station 180(5).

Charging station historical data 528 may include historical records collected from the previous pattern of charging or discharging of energy by the charging station 180(5). The historical records, for example, may include previous energy transfer sessions between the charging station 180(5) and other network components such as the truck 110 or bus 120, and mobile charging stations 176.

In one embodiment, the energy management server 130 may receive the data information of the truck 110, bus 120, the mobile charging stations 176, and the charging stations 180 to determine their respective configurations and anticipated energy needs. The energy management server 130 may then generate the first energy usage plan 138 based on the obtained configurations and energy requirements of the truck 110, bus 120, and the charging stations 180. In one embodiment, each of the truck 110, bus 120, and charging stations 180 may include different energy usage plans. In this regard, each of these network components may be configured based upon their own respective energy usage plans. Thereafter, the energy management server 130 may monitor disruptions based on the corresponding stored measurement thresholds as described above.

In one example, each of the charging station 180(5) and the truck 110 or bus 120 may include different energy usage operating periods. Correspondingly, the energy management server 130 may utilize different unit values and monitoring sequences for each of the charging station 180(5) and truck 110 or bus 120. For example, the energy management server 130 may use a predetermined time period with unit values of hours and minutes for the charging station 180(5) and truck 110, respectively. In this example, the energy management server 130 may use different time intervals (i.e., predetermined time periods) to monitor the charging station 180(5) and truck 110. Further, the energy management server 130 may combine other data information, such as state-of-charge level, electric grid source prices, distance traveled, etc., when monitoring the charging station 180(5) and truck 110.

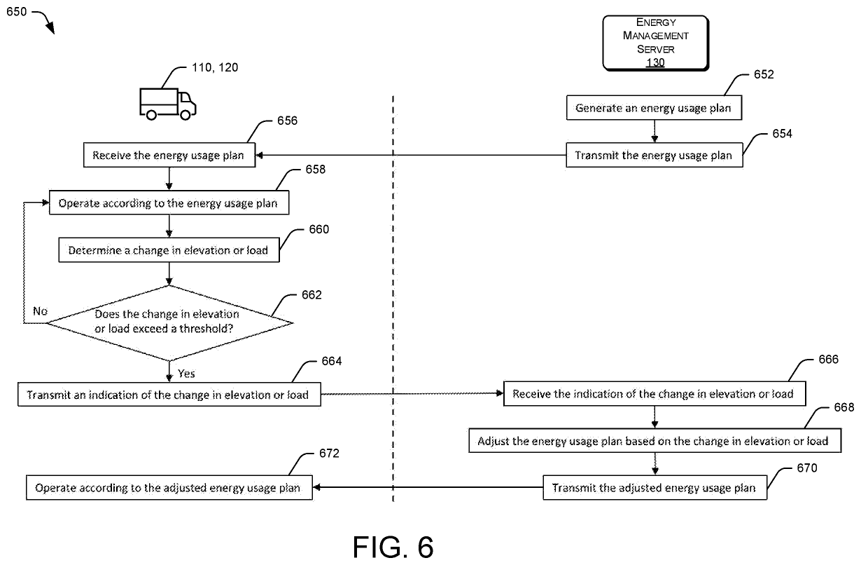

FIG. 6 is a flow diagram of a method 650 for adjusting the energy usage plan based on changes in elevation or load. The flow diagram illustrates actions performed by the energy management server 130 and/or a vehicle (e.g., the truck 110 or the bus 120). While the method 650 is described using steps in a specific sequence, it should be understood that the present disclosure contemplates that the described steps may be performed in different sequences than the sequence illustrated, and certain described steps may be skipped or not performed altogether.

At block 652, the energy management server 130 generates an energy usage plan (e.g., the first energy usage plan 138) as discussed above (e.g., with respect to block 202 of the flow diagram 200 of FIG. 2, block 308 of the flow diagram 300 of FIG. 3, and so on). At block 654, the energy management server 130 transmits the energy usage plan 138 to the vehicle (e.g., 110, 120).

At block 656, the vehicle 110, 120 receives the energy usage plan 138. At block 658, the vehicle 110, 120 operates according to the energy usage plan 138. For example, as described above, the vehicle 110, 120 may operate according to a charging plan schedule of the energy usage plan 138 that instructs the vehicle 110, 120 to travel to a mobile energy trading point 172 as part of a predetermined route and/or to perform energy transfers based on the energy usage plan 138.

At block 660, the vehicle 110, 120 determines a change in elevation or load. As an example, and as mentioned above, the vehicle 110, 120 may include an inclination, declination, tilt, motion, or any other suitable elevation sensor (e.g., an accelerometer, gyroscope, or the like) that may enable determining a change in elevation of the vehicle 110, 120. In some embodiments, the vehicle 110, 120 may include a GNSS (e.g., GPS) receiver that determines a global location of the vehicle 110, 120, and the vehicle 110, 120 may determine a change in elevation based on correlating or matching the global location of the vehicle 110, 120 to a location on a map 122 (e.g., the map indicating the elevation of the location). As such, the vehicle 110, 120 may determine that it is undergoing an increase in elevation (e.g., an uphill route) or a decrease in elevation (e.g., a downhill route). As another example, and as mentioned above, the vehicle 110, 120 may include load cells or other weight sensors that determine a change in weight of the vehicle 110, 120, including a change in weight of cargo in the truck 110 or a change in weight of passengers in the bus 120. For example, the truck 110 may determine that there is an increase in weight of the truck 110 because cargo is loaded onto the truck 110 (e.g., at a beginning of a route) and/or the truck 110 may determine that there is a decrease in weight of the truck 110 because cargo is unloaded from the truck 110 (e.g., at an end of the route). Similarly, the bus 120 may determine that there is an increase in weight of the bus 120 because passengers board the bus 120 (e.g., at a beginning of a route or at bus stops along the route) and/or the bus 120 may determine that there is a decrease in weight of the bus 120 because the passengers disembark the bus 120 (e.g., at an end of route or at bus stops along the route).

At block 662, the vehicle 110, 120 determines whether the change in elevation or load exceeds a threshold. The threshold may include any suitable threshold for which the energy usage plan 138 may be adjusted, including a 5% or less change in elevation or load, a 10% or less change in elevation or load, a 20% or less change in elevation or load, a 30% or less change in elevation or load, a 50% or less change in elevation or load, a 75% or less change in elevation or load, a 90% or less change in elevation or load, a 100% or less change in elevation or load, a 200% or less change in elevation or load, and so on.

If the vehicle 110, 120 determines that the change in elevation or load does not exceed the threshold, then the vehicle 110, 120 returns to and performs block 658. Otherwise, if the vehicle 110, 120 determines that the change in elevation or load exceeds the threshold, then, in block 664, the vehicle 110, 120 transmits an indication of the change in elevation or load to the energy management server 130. In process block 666, the energy management server 130 receives the indication of the change in elevation or load to the energy usage plan 138 from the vehicle 110, 120.

In process block 668, the energy management server 130 adjusts the energy usage plan 138 based on the change in elevation or load. That is, the energy management server 130 may adjust the energy usage plan 138 to provide more energy to the vehicle 110, 120 in the case of an increase in elevation or load, or provide less energy to the vehicle 110, 120 in the case of a decrease in elevation or load. In particular, the energy management server 130 may adjust the energy usage plan 138 based on the change in elevation or load to generate the second or subsequent energy usage plan 140, for example, as described in block 210 of the flow diagram 200 of FIG. 2, block 410 of the flow diagram 400 of FIG. 3, and so on.

For example, in the case of an increase in elevation or load, the adjusted energy usage plan 140 may include a charging plan schedule that provides longer charging duration or more frequent charging than the energy usage plan 138 generated in block 652. Similarly, in the case of an increase in elevation or load, the adjusted energy usage plan 140 may include instructions that cause the vehicle 110, 120 to travel to a greater number of charging stations or mobile energy trading points 172 and/or to perform a greater number or greater duration of energy transfers than the energy usage plan 138 generated in block 652. On the other hand, in the case of a decrease in elevation or load, the adjusted energy usage plan 140 may include a charging plan schedule that provides shorter charging duration or less frequent charging than the energy usage plan 138 generated in block 652. Similarly, in the case of a decrease in elevation or load, the adjusted energy usage plan 140 may include instructions that cause the vehicle 110, 120 to travel to a lesser number of charging stations or mobile energy trading points 172 and/or to perform a lesser number or lesser duration of energy transfers than the energy usage plan 138 generated in block 652.

In process block 670, the energy management server 130 transmits the adjusted energy usage plan 140 to the vehicle 110, 120. In process block 572, the vehicle 110, 120 operates according to the adjusted energy usage plan 140. For example, as described above, the vehicle 110, 120 may operate according to a charging plan schedule of the adjusted energy usage plan 140 that instructs the vehicle 110, 120 to travel to a mobile energy trading point 172 as part of a predetermined route and/or to perform energy transfers based on the adjusted energy usage plan 140.

In this manner, the method 650 may enable the vehicle 110, 120 and/or the energy management server 130 to adjust the energy usage plan (e.g., 138) based on changes in elevation or load.

### Example Energy Management Server

FIG. 7 is a block diagram of an example energy management server 130 that can facilitate management of energy usage plans throughout the energy distribution network 100. As shown, the energy management server 130 may include a communication interface 700, one or more processors 720, and a memory 750. Processors 720 may include the energy usage platform 722. The memory 750 may include a database 760 that further includes an energy usage plan 762, vehicle data information 764, charging station data information 766, and environmental data 768.

In one example, the energy management server 130 may establish communications with the network components through the communication interface 700. The communication interface 600 may include hardware, software, or a combination of hardware and software that transmits and/or receives data from the network components throughout the energy distribution network 100. Communication interface 700 may include a transceiver that facilitates wired or wireless communications through a cellular network or broadband network. For example, the communications can be achieved via one or more networks, such as, but are not limited to, one or more of WiMAX, a Local Area Network (LAN), Wireless Local Area Network (WLAN), a Personal area network (PAN), a Campus area network (CAN), a Metropolitan area network (MAN), or any broadband network, and further enabled with technologies such as, by way of example, Global System for Mobile Communications (GSM), Personal Communications Service (PCS), Bluetooth, Wi-Fi, Fixed Wireless Data, 2G, 5G (new radio), etc.

Processor(s) 720 may include one or more central processing unit(s) (CPU), graphics processing unit(s) (GPU), both a CPU and GPU, or any other sort of processing unit(s). Each of the one or more processor(s) 720 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution. The one or more processor(s) 720 may also be responsible for executing all computer applications stored in the memory, which can be associated with common types of volatile (RAM) and/or non-volatile (ROM) memory. For example, the processor(s) 720 may process data information that the energy management server 130 receives through the communication interface 700. In another example, the processor(s) 720 may use the communication interface 700 to send the notifications to the network components.

The energy usage platform 722 may include hardware, software, or a combination of hardware and software that may calculate optimal usage plans in the energy storage systems as described herein. The energy usage platform 722 may use different types and kinds of algorithms such as a k-means algorithm, maximum likelihood algorithm, nearest neighbor algorithm, etc. to calculate the optimal energy usages in the energy distribution network 100.

Memory 750 may be implemented using computer-readable media, such as computer-readable storage media, including at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc-Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms. The memory 750 may also include a firewall. In some embodiment, the firewall may be implemented as hardware in the energy management server 130.

Database 760 may store collected data information, historical data (including previous load weights), energy usage plans, algorithms, prediction models, GPS location and elevation data, and other information that can be collected from the network components in the energy distribution network 100. Energy usage plan 762 may store the energy usage plans that can be generated based upon received energy requirements, current configurations of the network components, etc. In one example, each of the energy usage plans may be associated with a particular energy usage operating period. Vehicle data information 764 may store the data information of the mobile energy consuming components that can also be configured as energy providing components. The charging station data information 766 may store the data information, parameters, and other information of the energy providing components.

### Example Energy Management Device of the Truck or Bus

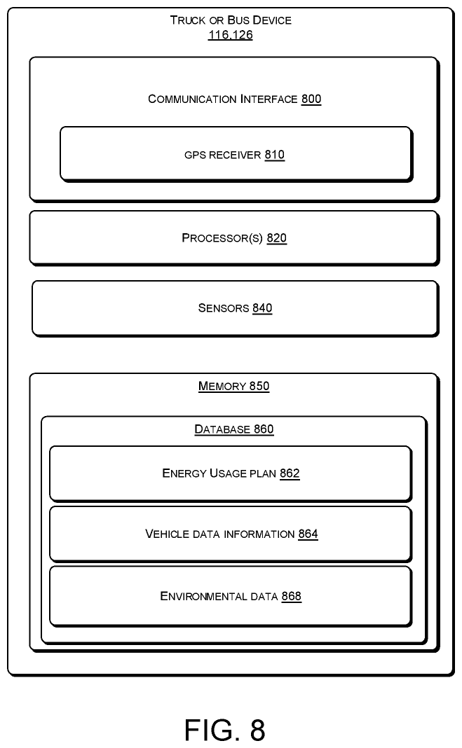

FIG. 8 is a block diagram of an example energy management device 116 of the truck 110 or energy management device 126 of the bus 120 that can interface with the energy management server 130 to control the operation of the truck 110 or bus 120, respectively, in accordance with the energy usage plan provided by the energy management server 130. As shown, the energy management device 116,126 may include a communication interface 800, one or more processors 820, sensors 840, and a memory 850. Processors 820 may include an electronic control unit (ECU) that manages the operation of electric motor(s) and batteries in the truck 110 or bus 120. The sensors 840 may include accelerometers, gyroscopes, or other similar devices that detect the inclination or declination of the truck 110 or bus 120 while driving, load cells or other weight sensors that measure the weight of the cargo in the truck 110 or the weight of the passengers in the bus 120, and sensors that monitor the velocity of the wheels of the truck 110 or bus 120. The velocity of the individual wheels may be indicative of the actual energy usage of the truck 110 or bus 120, which would be based on the speed of the truck/bus on the road that is affected by the roughness, deflection, or traction of the road. The memory 850 may include a database 860 that further includes a current energy usage plan 862, vehicle data information 864, and environmental data 868.

In one example, the energy management device 116,126 may establish communications with the energy management server 130 through the communication interface 800. The communication interface 800 may include hardware, software, or a combination of hardware and software that transmits and/or receives data from at least the energy management server 130. Communication interface 800 may include a transceiver that facilitates wired or wireless communications through a cellular network or the broadband network. For example, the communications can be achieved via one or more networks, such as, but are not limited to, one or more of WiMAX, a Local Area Network (LAN), Wireless Local Area Network (WLAN), a Personal area network (PAN), a Campus area network (CAN), a Metropolitan area network (MAN), or any broadband network, and further enabled with technologies such as, by way of example, Global System for Mobile Communications (GSM), Personal Communications Service (PCS), Bluetooth, Wi-Fi, Fixed Wireless Data, 2G, 5G (new radio), etc. Communication interface 700 may further include a GPS receiver 710 or other interface circuitry or software application or combination thereof for communicating with a wireless navigation system.

Processor(s) 820 may be one or more central processing units (CPUs) or other types of data processing circuits that may incorporate, for example, one or more arithmetic logic units (ALUs) that perform arithmetic and logical operations as well as one or more control units (CUs) that extract instructions and stored content from processor cache memory, and then execute these instructions by calling on the ALUs, as necessary during program execution. The one or more processor(s) 820 may also be responsible for executing all computer applications stored in the memory, which can be associated with common types of volatile (RAM) and/or non-volatile (ROM) memory. For example, the processor(s) 820 may process data information received from the energy management server 130 through the communication interface 800. In another example, the processor(s) 820 may use the communication interface 800 to send notifications or vehicle data to the energy management server 130. In a further example, the processor(s) 820 may process geolocation information received from the GPS receiver 810 of the communication interface 800, as well as inclination/declination, cargo weight and road condition information from the sensors 840.

Memory 850 may be implemented using computer-readable media, such as computer-readable storage media, including at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms. The memory 850 may also include a firewall. In some embodiment, the firewall may be implemented as hardware in the energy management server 130.

Database 860 may store collected data information, historical data (including previous energy usage rates, previous load weights), energy usage plans, algorithms, prediction models, GPS location and elevation data, and other information that may be generated by the energy management device 116,126 during the operation of the truck 110 or bus 120 and/or collected from the energy management server 130. Energy usage plan 862 may store the energy usage plan(s) that are generated by and received from the energy management server 130. In one example, the energy usage plan 862 may consist of the data initially received from the energy management server 130 (i.e., first energy usage plan) or data later received from the energy management server 130 resulting from changes or disruptions that require modification of the first energy usage plan. In another example, if more than one energy usage plan is stored, each such energy usage plan may be associated with a particular energy usage operating period. Vehicle data information 864 may store data information about the truck 110 or bus 120, including but limited to the current configuration and energy requirements of the truck 110 or bus 120; battery parameter data on the battery or batteries installed in the truck 110 or bus 120, such as capacity or state-of-charge level, depth of charge, charging and discharging rates of the battery, or the battery lifetime; maximum load carrying capacity of the truck or bus; and operating characteristics data of the truck or bus, including type of motor propulsion installed (e.g., electric motor only, hybrid motor system, single or multiple electric motors), maximum vehicle speed, and energy usage rate of the motor(s).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
generating, using one or more processors of an energy management server, an energy usage plan for a vehicle;
receiving, using a communication interface of the energy management server, an indication of a change in elevation of the vehicle; and
adjusting, using the one or more processors, the energy usage plan of the vehicle based on the change in the elevation.

2. The method of claim 1, comprising transmitting, using the communication interface, the energy usage plan, prior to adjusting the energy usage plan, to the vehicle.

3. The method of claim 1, transmitting, using the communication interface, the energy usage plan, after adjusting the energy usage plan, to the vehicle.

4. The method of claim 1, wherein the change in elevation of the vehicle comprises an increase in the elevation of the vehicle, and adjusting, using the one or more processors, the energy usage plan of the vehicle comprises providing an increase in energy to the vehicle.

5. The method of claim 1, wherein the change in elevation of the vehicle comprises a decrease in the elevation of the vehicle, and adjusting, using the one or more processors, the energy usage plan of the vehicle comprises providing a decrease in energy to the vehicle.

6. The method of claim 1, wherein the energy usage plan comprises a charging plan schedule for the vehicle.

7. The method of claim 1, wherein the energy usage plan comprises one or more instructions that cause the vehicle to travel to a mobile energy trading point as part of a predetermined route.

8. The method of claim 1, wherein the energy usage plan comprises one or more instructions that cause the vehicle to perform one or more energy transfers.

9. One or more tangible, non-transitory, computer-readable media storing instructions that, when executed by one or more processors, cause the one or more processors to:
receive a first energy usage plan from an energy management server;
transmit an indication of a change in elevation or load of a vehicle to the energy management server;
receive a second energy usage plan from the energy management server based on the indication; and
operate according to the second energy usage plan.

10. The one or more tangible, non-transitory, computer-readable media of claim 9, wherein the instructions cause the one or more processors to operate according to the first energy usage plan prior to receiving the second energy usage plan.

11. The one or more tangible, non-transitory, computer-readable media of claim 9, wherein the instructions cause the one or more processors to receive the elevation of the vehicle from an elevation sensor of the vehicle.

12. The one or more tangible, non-transitory, computer-readable media of claim 9, wherein the instructions cause the one or more processors to receive the elevation of the vehicle based on a global position of the vehicle.

13. The one or more tangible, non-transitory, computer-readable media of claim 12, wherein the instructions cause the one or more processors to receive the global position from a global navigation satellite system receiver of the vehicle.

14. The one or more tangible, non-transitory, computer-readable media of claim 9, wherein the instructions cause the one or more processors to receive the load of the vehicle from a weight sensor of the vehicle.

15. The one or more tangible, non-transitory, computer-readable media of claim 9, wherein the instructions cause the one or more processors to:
determine whether the change in elevation or load of the vehicle exceeds a threshold; and
transmit the indication of the change in elevation or load of the vehicle to the energy management server based on the change in elevation or load of the vehicle exceeding the threshold.

16. An energy management server comprising:
a communication interface; and
one or more processors coupled to the communication interface, wherein the one or more processors are configured to:
generate a first energy usage plan for a vehicle;
receive an indication of a change in load of the vehicle;
generate a second energy usage plan of the vehicle based on the change in the load.

17. The energy management server of claim 16, wherein the change in load of the vehicle comprises an increase in the load of the vehicle, and the one or more processors are configured to generate the second energy usage plan of the vehicle by providing an increase in energy to the vehicle.

18. The energy management server of claim 16, wherein the change in load of the vehicle comprises a decrease in the load of the vehicle, and the one or more processors are configured to generate the second energy usage plan of the vehicle by providing a decrease in energy to the vehicle.

19. The energy management server of claim 16, wherein the first energy usage plan comprises a first duration of energy transfers, and the second energy usage plan comprises a second duration of energy transfers greater than the first duration.

20. The energy management server of claim 16, wherein the first energy usage plan comprises a first frequency of energy transfers, and the second energy usage plan comprises a second frequency of energy transfers greater than the first frequency.
